(19) United States
(12) Patent Application Publication
(10) Pub. No.: US 2023/0269159 A1
(43) Pub. Date: Aug. 24, 2023

(54) DETERMINING AN EGRESS INTERFACE FOR A PACKET USING A PROCESSOR OF A NETWORK DEVICE

(71) Applicant: Arista Networks, Inc., Santa Clara, CA (US)

(72) Inventors: Sriram Sellappa, Santa Clara, CA (US); Chandramouleeswaran S. Baskaran, Santa Clara, CA (US)

(21) Appl. No.: 17/676,529

(22) Filed: Feb. 21, 2022

(51) Int. Cl. H04L 45/12; H04L 45/24; H04L 45/42; H04L 45/00

(52) U.S. Cl. CPC H04L 45/123; H04L 45/24; H04L 45/42; H04L 45/566

(57) ABSTRACT

In general, embodiments relate to a method, for managing a network device, that includes obtaining a packet by a network device in the network, making a determination that the packet meets a lifecycle-ending condition, wherein when the packet meets the lifecycle-ending condition the packet is not forwarded from the network device towards a network device associated with a destination internet protocol (IP) address in a header of the packet, based on the determination, performing, by the network device, a packet analysis on the packet to determine an egress interface of the network device associated with the packet, and based on the packet analysis, sending a notification to a network monitoring manager, wherein the notification specifies the egress interface.

### BACKGROUND

Network devices in a network may include functionality for transmitting packets between each other and other devices in a network. Based on any number of factors relating to the network, the configuration of the network may prevent the packets from reaching their destinations.

### BRIEF DESCRIPTION OF DRAWINGS

FIG. 1A shows a diagram of a system in accordance with one or more embodiments.

FIG. 1B shows a diagram of a network device in accordance with one or more embodiments.

FIG. 2A shows a flowchart for a method for managing packets by a hardware layer in accordance with one or more embodiments.

FIG. 2B shows a flowchart for a method for processing a packet that meets a lifecycle-ending condition in accordance with one or more embodiments.

FIGS. 3A-3B show an example in accordance with one or more embodiments described herein.

FIG. 4 shows a diagram of a computing device in accordance with one or more embodiments described herein.

### DETAILED DESCRIPTION

During operation of a network that includes any number of network devices in which network traffic operates, data transferred along the network traffic may be undesirably lost. The loss of data may be caused by inefficient or otherwise undesirable network paths along which the data travels. The network paths may comprise any number of network devices. For example, packets may travel along network paths that embody a loop of network devices that, regardless of the number of hops between network devices, the packet may never reach the intended target destination. Such loops of network devices may be caused by a failure of other network devices to properly operate.

To mitigate the network traffic caused by packets traveling without reaching a destination, current implementations of the network may provide policies for limiting the lifespan of packets traveling within the network. An example of such policies may include a time to live (TTL) mechanism. The TTL mechanism may be implemented by including a header of each packet that may be used to determine how long such a packet has been traveling within the network. When a TTL value reaches a predetermined value, the network device that makes that determination drops the packet. In one or more embodiments, a packet being dropped refers to not transmitting a packet using its header information to another network device. The packet being dropped may further refer to deleting the packet from the network device, thus removing the packet from traveling along a network.

A network monitoring manager of a network may be used to monitor the operation of the network. The operation of the network may be monitored by measuring parameters such as, for example, (i) the number of available network paths between any pair of source and destination entities, (ii) the number of network devices typically used to send packets from a particular source entity to a particular destination entity, and (iii) an amount of packets not reaching a destination entity as it traverses the network. To perform the monitoring of the operation of the network, the network monitoring manager may initiate sending a predetermined amount of probe packets for the purpose of identifying which probe packets reach an intended destination entity. The operation may be costly due to the amount of increased network traffic applied to the network to perform the monitoring. Further, the operation may not provide any data probing information. Because a packet may be dropped while traveling across the network, the network monitoring manager may not obtain any information associated with the network path of a dropped packet. This may result in a wasted attempt by the network monitoring manager to monitor the network. Improving the efficiency of performing the monitoring would improve the overall operation of the network. To improve the efficiency, it would be beneficial to obtain additional information from packets being dropped in the network.

To provide such additional information, embodiments may include initiating a method of processing packets that meet a predetermined criterion (or criteria) to obtain additional information regarding the network path of the packet. The predetermined criterion may include, for example, the TTL value reaching a critical value that results in the packet being dropped. The additional information may include, for example, an egress interface that would have been used to send the packet to the next entity in the network path.

Embodiments include obtaining, by a forwarding chip of a network device performing the forwarding of packets to network devices, a packet. A determination may be made, either by the forwarding chip or by a processor of the network device, that the packet meets the predetermined criteria for performing a trapping of the packet. The determination may be made based on the header of the packet, which may specify that the packet is to be dropped instead of forwarded to another network device. For example, a TTL value of the header may specify the dropping of the packet. After trapping the eligible packet, the processor may perform a data processing on the packet to determine an egress interface (e.g., an egress port) out of which the packet would have been forwarded. The determined egress information may be provided to a network monitoring manager. The network monitoring manager may be, for example, a network controller operated by an administrator of the network.

The network monitoring manager may utilize the obtained egress interface to improve the monitoring of the network. For example, the network monitoring manager may update the network paths intended to be monitored to determine whether the packets are traveling along the intended network paths.

Various embodiments of the disclosure are described below.

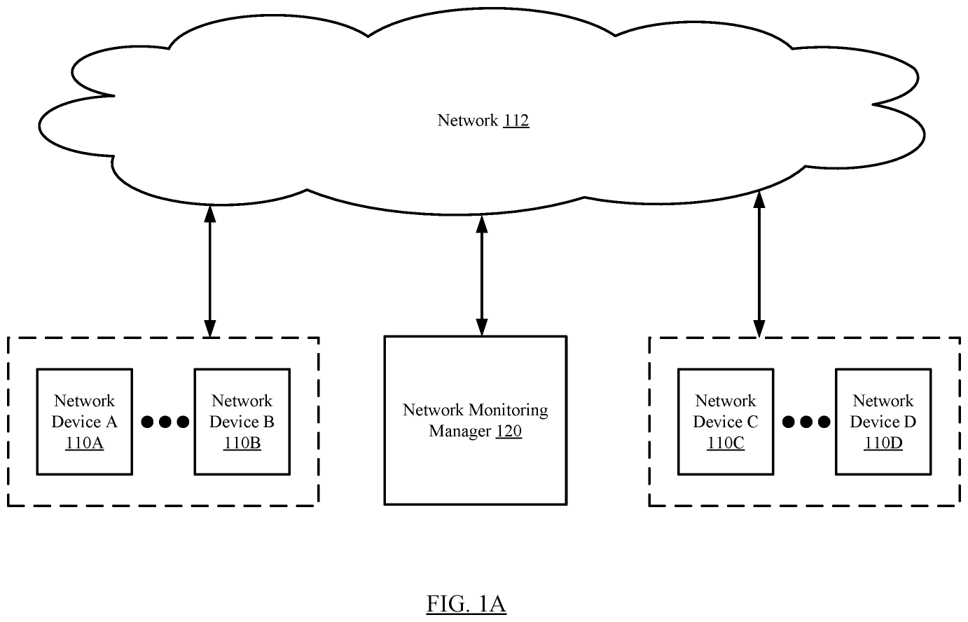

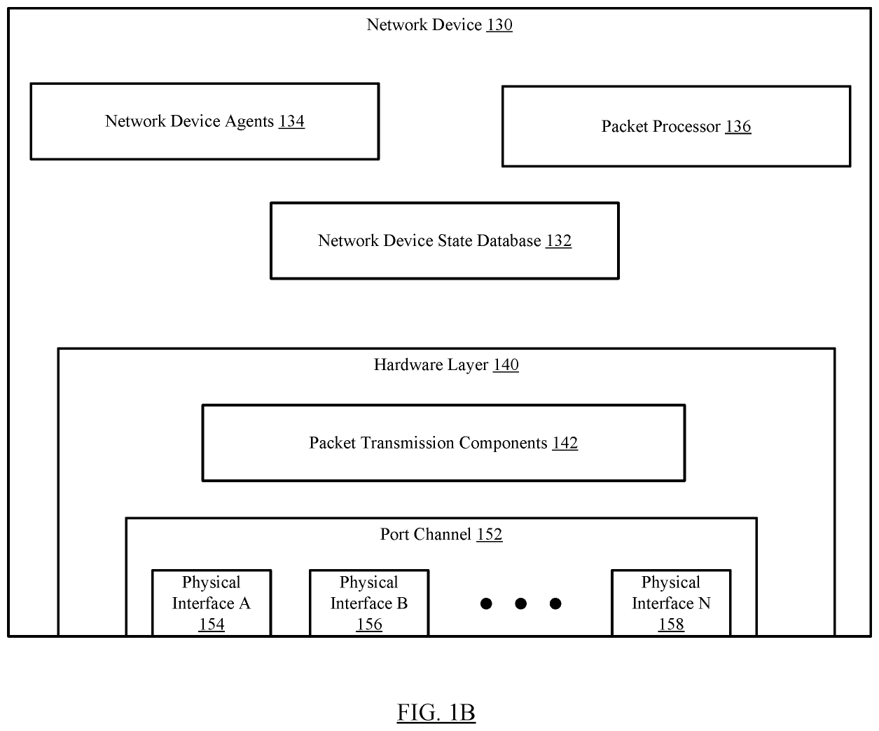

FIG. 1A shows a system in accordance with one or more embodiments of the disclosure. As shown in FIG. 1A, the system includes a network (112) that includes one or more network devices (110A, 110B, 110C, 110D). Further, the system includes a network monitoring manager (120). Each of these components is operatively connected via any combination of wired and/or wireless connections without departing from the disclosure. The system may include additional, fewer, and/or different components without departing from the disclosure. Each of the aforementioned components illustrated in FIG. 1A is described below.

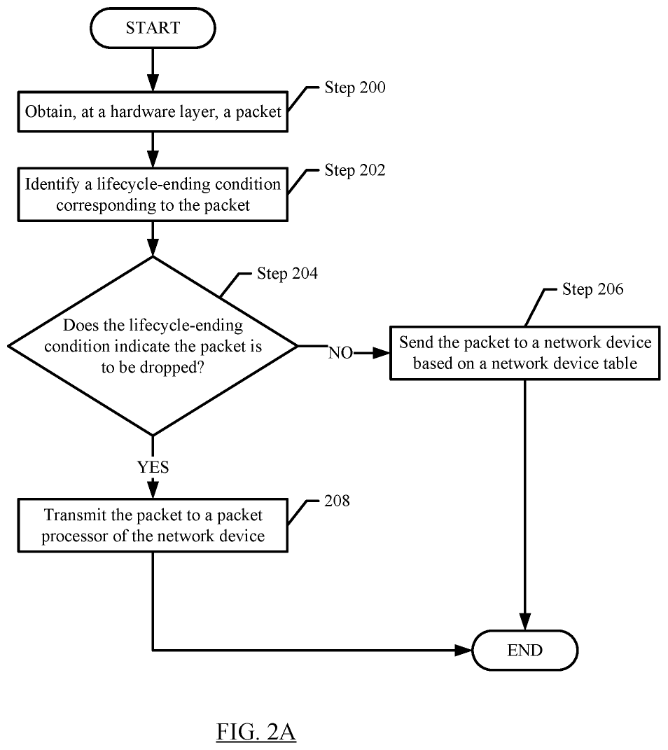

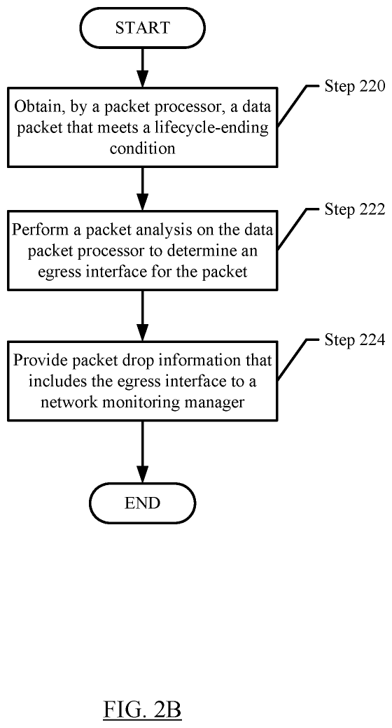

In one or more embodiments, each of the network devices (e.g., 110A, 110B, 110C, 110D) includes functionality to receive packets at any of the physical network interfaces (e.g., ports) of the network device (further discussed in FIG. 1B) and to process the packets. In one or more embodiments, the network device includes functionality for transmitting packets between network devices (110A, 110B, 110C, 110D) and/or between components in a network device (110A, 110B, 110C, 110D). The process of receiving packets, processing the packets, and transmitting the packets may be in accordance with, at least in part, FIGS. 2A and 2B.

In one or more embodiments, the transmission of packets across network devices (110A, 110B, 110C, 110D) may result in packets not reaching an expected destination. Any issues with the configuration of the network may result in such an outcome. For example, by implementing a routing and/or forwarding protocol, the network devices (110A, 110B, 110C, 110D) may send packets along a path that loops between a set of network devices. In this scenario, the network devices in the network loop may not be configured to provide the packet to the intended destination. In other words, the packet may travel along the network loop ad infinitum.

To reduce the effect of network traffic caused by packets traveling on network loops, the packets may include information provided to each network device (110A, 110B, 110C, 110D) that specifies a condition for dropping the packet (e.g., not transmitting the packet to another network device based on the header of the packet). By considering such a condition (also referred to as a lifecycle-ending condition), the network traffic in the network (112) is not overwhelmed by packets that are traveling along the network without ever reaching their destinations.

To manage the network (112) and reduce the issues that may cause network loops (or other problems in the network (112)), the network (112) may include a network monitoring manager (120). The network monitoring manager (120) may obtain network information regarding the network devices (110A, 110B, 110C, 110D) in the network (112) and utilize such obtained information to optimize, remediate, and/or otherwise manage the operation of the network (112). For example, the network devices (112) may be optimized to reduce the number of network devices in a path needed to transfer data from one device to another device along the network (112). As another example, the network monitoring manager (120) may implement updates to protocols applied by the network devices (110A, 110B, 110C, 110D). The network monitoring manager (120) may include other functionalities for managing the operation of the network (112) in accordance with one or more embodiments.

In one or more embodiments, a network device (110A, 110B, 110C, 110D) processing a packet that meets a lifecycle-ending condition may, as a result of the processing, generate information to be used to improve the operation of the network (112). The information may be, for example, an egress interface in accordance with FIG. 2A. The network monitoring manager (120) may obtain such information and perform remediation in accordance with, for example, FIG. 2B.

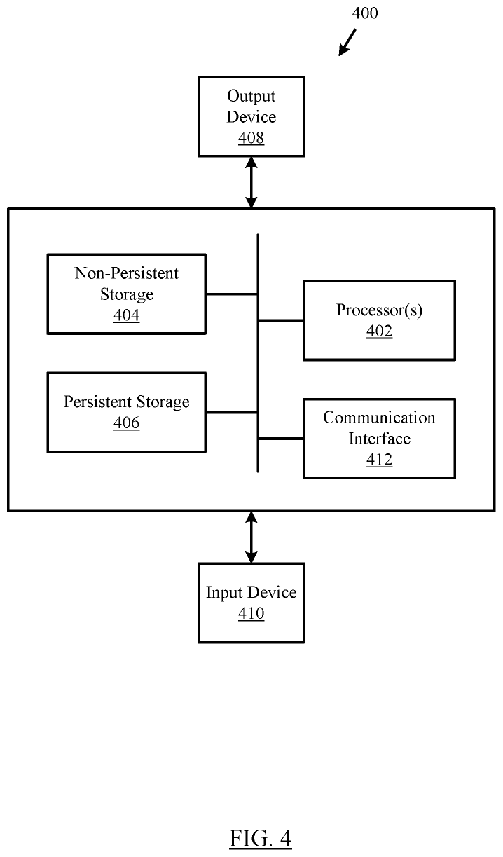

In one or more embodiments, the network monitoring manager (120) is implemented as a computing device (see, e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that, when executed by the processor(s) of the computing device, cause the computing device to perform the functionality of the network monitoring manager (120) described throughout this application.

In one or more embodiments disclosed herein, the network monitoring manager (120) is implemented as a logical device. The logical device may utilize the computing resources of any number of computing devices and thereby provide the functionality of the network monitoring manager (120) described throughout this application.

While the network monitoring manager (120) is illustrated as a separate component, the network monitoring manager (120) may be implemented as a network device (110A, 110B, 110C, 110D). Alternatively, the network monitoring manager (120) may be implemented as computing instructions implemented by the network device (110A, 110B, 110C, 110D) that cause the network device to provide the functionality of the network monitoring manager (120) disclosed throughout this application.

In one embodiment of the disclosure, the one or more network device(s) (110A, 110B, 110C, 110D) are physical devices (not shown) that include persistent storage, memory (e.g., random access memory), one or more processor(s), network device hardware (including a switch chip(s), line cards, etc.), and two or more physical ports. In one embodiment of the disclosure, the network device is hardware that determines which egress port on a network device to forward media access control (MAC) frames. Each physical port (further discussed in FIG. 1B) may or may not be connected to another device (e.g., a client device, another network device) on the network (112). The network device (or more specifically the network device hardware) may be configured to receive packets via the ports and determine whether to: (i) drop the packet; (ii) process the packet in accordance with one or more embodiments of the disclosure; and/or (iii) send the packet, based on the processing, out from another port on the network device. While the aforementioned description is directed to network devices that support Ethernet communication, the disclosure is not limited to Ethernet; rather, the disclosure may be applied to network devices using other communication protocols. For additional details regarding a network device (e.g., 110A, 110B, 110C, 110D), see, e.g., FIG. 1B.

FIG. 1B shows a diagram of a network device in accordance with one or more embodiments of the disclosure. The network device (130) may be an embodiment of a network device (e.g., 110A, FIG. 1A) discussed above. As discussed above, the network device (130) may include functionality for transmitting packets between network devices. To perform the aforementioned functionality, the network device (130) includes a network device state database (132), one or more network device agents (134), a packet processor (136), and a hardware layer (140). The network device (130) may include additional, fewer, and/or different components without departing from the disclosure. Each of the aforementioned components illustrated in FIG. 1B is described below.

In one embodiment of the disclosure, the network device state database (132) includes the current state of the network device (130). The state information stored in the network device state database (132) may include, but is not limited to: (i) information about (and/or generated by) all (or a portion thereof) services currently executing on the network device; (ii) the version of all (or a portion thereof) software executing on the network device; (iii) the version of all firmware on the network device; (iv) hardware version information for all (or a portion thereof) hardware in the network device; (v) information about the current state of all (or a portion thereof) tables (e.g., routing table, forwarding table, etc.) in the network device that are used to process packets, where information may include the current entries in each of the tables, and (vi) information about all (or a portion thereof) services, protocols, and/or features configured on the network device (e.g., show command service (SCS), MLAG, LACP, VXLAN, LLDP, tap aggregation, data center bridging capability exchange, ACL, VLAN, VRRP, VARP, STP, OSPF, BGP, RIP, BDF, MPLS, PIM, ICMP, IGMP, etc.), where this information may include information about the current configuration and status of each of the services, protocols, and/or features. In one embodiment of the disclosure, the network device state database (132) includes control plane state information associated with the control plane of the network device. Further, in one embodiment of the disclosure, the state database includes data plane state information (discussed above) associated with the data plane of the network device. The network device state database (132) may include other information without departing from the disclosure.

In one embodiment of the disclosure, the network device state database (132) may be implemented using any type of database (e.g., a relational database, a distributed database, etc.). Further, the network device state database (132) may be implemented in-memory (i.e., the contents of the state database may be maintained in volatile memory). Alternatively, the network device state database (132) may be implemented using persistent storage. In another embodiment of the disclosure, the network device state database (132) may be implemented as an in-memory database with a copy of the state database being stored in persistent storage. In such cases, as changes are made to the in-memory database, copies of the changes (with a timestamp) may be stored in persistent storage. The use of an in-memory database may provide faster access to the contents of the network device state database (132).

Those skilled in the art will appreciate that while the term “database” is used above, the network device state database (132) may be implemented using any known or later developed data structure(s) to manage and/or organize the content in the state database.

In one embodiment of the disclosure, the network device (130) further includes one or more network device agents (134). The network device agents (134) interact with the network device state database (132). Each network device agent (134) facilitates the implementation of one or more protocols, services, and/or features of the network device (130). Examples of network device agents include, but are not limited to, a routing information base agent, a forwarding information base agent, and a simple network management protocol (SNMP) agent. Furthermore, each network device agent includes functionality to access various portions of the network device state database (132) in order to obtain the relevant portions of the state of the network device (130) in order to perform various functions. Additionally, each network device agent includes functionality to update the state of the network device (130) by writing new and/or updated values in the network device state database (132), corresponding to one or more variables and/or parameters that are currently specified in the network device (130).

In one or more embodiments disclosed herein, the packet processor (136) obtains packets that meet a lifecycle-ending condition from the hardware layer (140) and process such packets to obtain packet drop information. The packet processor (136) may operate on the control plane of the network device (130). The control plane may be further used to perform routing processing to generate forwarding tables. The forwarding tables may be provided to the hardware layer (140). The packets may be processed by the packet processor (136) in accordance with FIG. 2B.

In one or more embodiments disclosed herein, the packet processor (136) is a physical device. The physical device may include circuitry. The physical device may be, for example, a field-programmable gate array, application specific integrated circuit, programmable processor, microcontroller, digital signal processor, or other hardware processor. The physical device may be adapted to provide, at least partly, the functionality of the packet processor (136) described throughout this application.

In one or more embodiments disclosed herein, the packet processor (136) is implemented as computer instructions (e.g. computer code) stored on a persistent storage that when executed by a processor of the network device (130) cause the network device (130) to provide the functionality of the packet processor (136) described throughout this application and/or all or a portion of the methods illustrated in FIG. 2B.

In one or more embodiments, the hardware layer (140) includes packet transmission components (142), and port channels (152). In one or more embodiments, the hardware layer (140) includes at least two physical interfaces (e.g., physical interface A (154) and physical interface B (156)). In one or more embodiments, physical interfaces (154, 156, 158) are any hardware, software, or combination thereof that include functionality to receive and/or transmit network traffic data units or any other information to or from network device (130). The physical interfaces (154, 156, 158) may include any interface technology, such as, for example, optical, electrical, etc. The physical interfaces (154, 156, 158) may be configured to interface with any transmission medium (e.g., optical fiber, copper wire(s), etc.).

In one or more embodiments, physical interfaces (154, 156, 158) include and/or are operatively connected to any number of components used in the processing of packets. For example, a given physical interface may include a physical layer (PHY) (not shown), which is circuitry that connects a physical information propagation medium (e.g., a wire) to other components, which process the information. In one or more embodiments, the physical interfaces (154, 156, 158) include and/or are operatively connected to a transceiver, which provides the connection between the physical information transmission medium and the PHY. A PHY may also include any number of other components, such as, for example a serializer/deserializer (SERDES), and encoder/decoder, etc. A PHY may, in turn, be operatively connected to any number of other components, such as, for example, a media access control (MAC) sublayer. Such a sublayer, may, in turn, be operatively connected to still other higher layer processing components, all of which form a series of components used in the processing of packets being received or transmitted. The physical interfaces (154, 156, 158) may be ingress ports (e.g., ports that received packets from other network devices) or egress ports (e.g., ports that provide packets to other network devices).

In one or more embodiments, physical interfaces have an associated bandwidth. In one or more embodiments, bandwidth of a physical interface is a throughput capacity of the interface. Bandwidth may be measured in bits per second (e.g., gigabits per second (Gbps)). Any other quantification of bandwidth may be used without departing from the scope of embodiments discussed herein.

In one or more embodiments, any physical interfaces (154, 156, 158) of the network device (130) may be part of the port channel (152). In one or more embodiments, a port channel (e.g., port channel (152)) is a communication link between two network devices supported by matching channel group interfaces on each network device. A port channel (e.g., port channel (152)) may also be referred to as a Link Aggregation Group (LAG). In one or more embodiments, port channels (e.g., port channel (152)) combine the bandwidth of multiple physical interfaces (e.g., 154, 156, 158) into a single logical link. A port channel (e.g., 152) may be a set of physical interfaces on a single network chip of network device (130), or may span physical interfaces of two or more network chips. Any selection of physical interfaces of a network device that are logically grouped together may be considered a port channel without departing from the scope of embodiments described herein.

In one or more embodiments, the packet transmission components (142) include functionality for obtaining packets from the physical interfaces (154, 156, 158) and transmitting the obtained packets. The packet transmission components (142) may be implemented as, for example, forwarding chips. The forwarding chips may utilize forwarding tables of the network device (130) to determine which network devices to forward the obtained packets.

In one or more embodiments disclosed herein, the packet transmission components (142) are physical devices. The physical devices may be, for example, a field-programmable gate array, application specific integrated circuit, programmable processor, microcontroller, digital signal processor, or other hardware processor. The physical device may be adapted to provide the functionality of the packet transmission components (142) described throughout this application and/or in the method described in FIG. 2A.

FIG. 2A shows a flowchart of a method for managing packets at a hardware layer in accordance with one or more embodiments. The method of FIG. 2A may be performed by, for example, a network device (e.g., 130, FIG. 1B). Other components illustrated in FIGS. 1A-1B may perform the method of FIG. 2A without departing from the disclosure.

While the various steps in the flowchart shown in FIGS. 2A-2B are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 200, a packet is obtained at a hardware layer. In one or more embodiments, the packet is obtained from another network device. In one or more embodiments, the packet is obtained from an ingress port of the network device. The packet may specify the contents of the data to be sent to its intended destination. The packet may further include a header that specifies information to be used by the forwarding chip to identify the next network device to send the packet.

In one or more embodiments of the disclosure, the packet is a probing packet. In one or more embodiments, a probing packet refers to a packet originally sent by the network monitoring manager to traverse a network path that includes a predetermined set of network devices and intended to return to the network monitoring manager. The network monitoring manager may send a large number of probing packets, each assigned a unique predetermined network path to traverse and each intended to return to the network monitoring manager. The network monitoring manager may utilize the actual obtained probing packets to determine a health state of the network. For example, the network monitoring manager may send a probing packet intended to traverse a network path that ends with the network monitoring manager. In one or more embodiments, the network monitoring manager may modify the header of the probing packet based on the monitoring to influence the path taken by the data packet. For example, the network monitoring manager may modify a transmission control protocol (TCP) port number of the header that are used by network devices to determine where to forward the packet. In this manner, the network monitoring manager may influence the path in which the packet travels. In this example, the probing packet may return to the network monitoring manager. In this scenario, the network monitoring manager may determine that one or more of the network devices in the network path are not operating properly. The network monitoring manager may send additional probing packets intended to traverse additional network paths that may each include at least a portion of the network devices of the first network path to identify the one or more network devices not operating properly. The network monitoring manager may remediate accordingly.

While the above example discusses modifying the TCP port number, other portions of the header may be modified, such as, for example, a user datagram protocol. Other portions of the header may be modified without departing from the invention.

In step 202, a lifecycle-ending condition is identified. In one or more embodiments, the lifecycle-ending condition is a condition that specifies whether the packet is not to be forwarded, or otherwise sent, to another network device. If the packet meets the lifecycle-ending condition, the packet is to be dropped. The lifecycle-ending condition may be identified using the header of the packet. For example, the header may include a time-to-live (TTL) value that specifies the number of remaining hops from one network device to another network device in a network path before the packet is to be dropped. The TTL value may decrease after each hop as it travels the network path. The TTL value may be reduced by the network device before the lifecycle-condition is identified in step 202 or after without departing from this disclosure. If the TTL value is reduced before step 202, the lifecycle condition may specify that the packet is to be dropped if the TTL value is 0. Alternatively, if the TTL value is to be reduced after step 202, the lifecycle condition may specify that the packet is to be dropped if the TTL value is 1. Other lifecycle conditions may be applied relating to the TTL value without departing from the disclosure.

In step 204, a determination is made about whether the lifecycle-ending condition indicates that the packet is to be dropped. If the lifecycle-ending condition indicates the packet is to be dropped, the method proceeds to step 208; otherwise, the method proceeds to step 206.

In step 206, following the determination that the lifecycle-ending condition corresponding to the packet does not indicate dropping the packet, the packet is sent to a network device based on a network device table. In one or more embodiments, a packet transmission component of the hardware layer (e.g., a forwarding component) may utilize a network device table (e.g., a forwarding table) to identify the network device to send the packet. The packet transmission component may further use the header of the packet to identify the network device to which the packet is forwarded. For example, the header may include an IP address. The packet transmission component may utilize the specified IP address to determine the egress interface to utilize to send the packet. The hardware layer may send the packet along the determined egress interface. Further, the header of the packet may be updated based on the forwarding. For example, if the header includes a TTL value, the TTL value may be updated to indicate that a hop has occurred. The TTL value may be updated by reducing the TTL value by 1.

In step 208, the packet is sent to a packet processor of the network device. The packet may be sent with a notification that the packet is to be processed to obtain information relating to the packet. The information may be, for example, the egress interface to which the packet was to be sent. In traditional implementations, because the packet meets a lifecycle ending condition, the packet transmission component does not further process the packet to identify the intended egress interface. As a result, no other entity (including the control plane of the network device) is aware of the egress interface that would have been used to forward the packet if the packet did not meet the lifecycle ending condition. By providing the packet to the packet processor, the packet may be processed to obtain information that, otherwise, may not be obtained for a dropped packet. In this manner, the packet is not forwarded or dropped as discussed throughout this disclosure.

In one or more embodiments, the packet is processed by the packet processor in accordance with FIG. 2B.

FIG. 2B shows a flowchart of a method for processing a packet in accordance with one or more embodiments. The method of FIG. 2B may be performed by, for example, a network device (e.g., 130, FIG. 1C). Other components illustrated in FIGS. 1A-1B may perform the method of FIG. 2B without departing from the disclosure.

While the various steps in the flowchart shown in FIG. 2B are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 220, a packet processor obtains a packet that meets a lifecycle-ending condition. In one or more embodiments, the packet is the packet of FIG. 2A that is determined to have met a lifecycle-ending condition.

In step 222, a packet analysis is performed on the packet processor to determine an egress interface for the packet. In one or more embodiments, the packet analysis includes a process for analyzing the packet to identify an egress interface (e.g., an egress port) that would have been used to send the dropped packet to another network device. The packet analysis may include analyzing the header of the packet to determine one or more addresses (e.g., MAC address, IP address) specified in the header, determining the network device corresponding to the specified address(es), and determining which egress interface is connected to an ingress interface of the determined network device. The packet analysis may include other processes performed on the dropped packet without departing from the disclosure.

In step 224, packet drop information is provided to the network monitoring manager. In one or more embodiments, the packet drop information may specify the determined egress interface of step 222. In one or more embodiments, the packet drop information is used by the network monitoring manager to improve the network management functionality of the network monitoring manager.

For example, the network monitoring manager may identify a culprit in the failure of the packet reaching its intended destination by identifying, based on the egress interface, a next-hop network device to which the packet would have been forwarded. In this example, the network monitoring manager may communicate directly with the identified next-hop network device to determine any issues corresponding to the configuration of the forwarding by the identified network device. Alternatively, the network monitoring manager may send additional probing packets with a modified network path that may include the identified next-hop network device and not include the network device performing the packet processing of FIGS. 2A-2B. In this manner, the network monitoring manager may further evaluate the network to potentially identify which network device, if any, in the network path of the dropped packet is culpable in the packet not reaching its destination.

As another example. The network monitoring manager may utilize the packet drop information of the network device and of other network devices performing the processing of FIGS. 2A-2B to collect a database of next-hop network devices and/or identifiers of the egress interfaces that do not receive packets due to drops by previous network devices. The database may further include identifiers of the egress interfaces obtained by network devices that dropped packets and processed the packets to obtain packet drop information. The database may be used to further improve the operational state of the network by improving the routing configurations of one or more network devices in the network to reduce drops of packets by the next-hop network devices specified in the database.

### Example

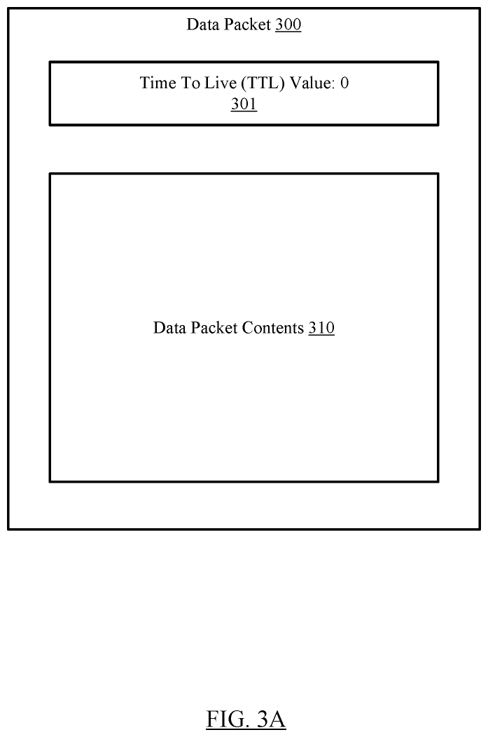

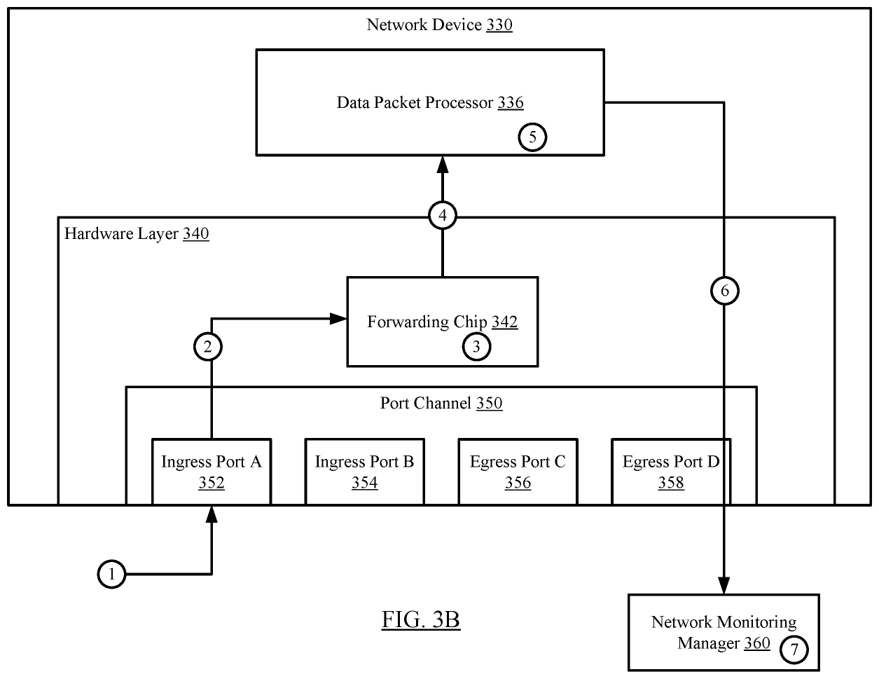

This section describes an example in accordance with one or more embodiments. The example is not intended to limit the scope of this disclosure. Turning to the example, FIGS. 3A-3B shows an example in accordance with one or more embodiments. The example shows a packet (300) that includes a TTL value (301) that is specified to be 0. The packet further includes packet contents (310) to be sent to a destination network device. The packet (300) has traversed a network loop in a network. By being stuck in a network loop, the packet (300) never reaches the destination network device. After several hops between the network devices in the network loop, the TTL value has decreased until the TTL value (301) has reached 0.

FIG. 3B shows a diagram of an example network device. The network device (330) includes a packet processor (336) and a hardware layer (340). The hardware layer includes a forwarding chip (342) and a port channel (350) that includes ingress ports A and B (352, 354) and egress ports C and D (356, 358).

The network device (330) obtains the packet from a second network device [1]. At this point in time, the TTL value of the packet has reached 0, as illustrated in FIG. 3A. The packet is obtained via ingress port A (352) of the port channel (350) and provided to a forwarding chip (342) of the hardware layer (340) [2]. The forwarding chip (342) reads the packet to identify the lifecycle-ending condition of the packet in accordance with FIG. 2A. The forwarding chip determines that, because the TTL value is 0, the packet meets the lifecycle-ending condition.

Based on this determination, rather than dropping the packet, the packet is provided to the packet processor (336) [4]. The packet processor (336) performs the method of FIG. 2B to perform a packet analysis that results in packet drop information associated with the dropped packet [5]. The packet drop information includes the egress port that would have been used to forward the packet. While this example discusses the packet drop information that specifies the egress port, embodiments disclosed herein may include other information. Such information may include, for example, a MAC address and/or an IP address for the next hop network device. Based on the data processing, the packet processor (336) determines that the egress port that the packet would have been processed through is egress port C (356). Based on this information, the packet processor (336) initiates communication with a network monitoring manager (360) via egress port D (358). The communication includes providing packet drop information that specifies the packet and the determined egress port [6]. The network monitoring manager (360), using the obtained packet drop information, provides the information to an administrator of the network for further evaluation. By providing the packet drop information to the administrator, the administrator is made aware of the behavior of the network path. Such behavior may specify the next hop of the data packet had it not met the lifecycle ending condition. In this example, the network device may be a network edge device, meaning, for example, the network device to which the packet would have been sent is managed by a different network monitoring manager and/or a different network provider. Because of this, without providing the packet drop information, neither network monitoring manager may be aware of the failure on the network path.

End of Example

As discussed above, embodiments of the disclosure may be implemented using computing devices. FIG. 4 shows a diagram of a computing device in accordance with one or more embodiments of the disclosure. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of the components illustrated in FIG. 4 is described below.

In one embodiment of the disclosure, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the disclosure, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Embodiments described herein allow for the operation of monitoring and/or otherwise managing a network. Specifically, embodiments disclosed herein enable a network device to obtain the required information to determine an egress interface for packets that would have been dropped. Without implementations disclosed herein, packets that are conditioned to be dropped from the network would not be transported to another network device via an egress port. As such, a hardware layer may not process a packet that meets such conditions.

Being aware of the egress interface may benefit a network monitoring manager to be used for managing the network. The identified egress interface may provide insight into how the network would have managed a packet that would not have reached its intended destination. The network monitoring manager may utilize such information to improve the network to reduce dropped packets and/or to reduce the causation of network loops that result in packets not reaching their intended destinations.

Specific embodiments have been described with reference to the accompanying figures. In the above description, numerous details are set forth as examples. It will be understood by those skilled in the art, and having the benefit of this Detailed Description, that one or more embodiments described herein may be practiced without these specific details and that numerous variations or modifications may be possible without departing from the scope of the embodiments. Certain details known to those of ordinary skill in the art may be omitted to avoid obscuring the description.

In the above description of the figures, any component described with regard to a figure, in various embodiments, may be equivalent to one or more like-named components shown and/or described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

1. A method for managing a network, the method comprising:
generating a probing packet by a network monitoring manager in the network, the probing packet configured to traverse a network path that includes a predetermined set of network devices and returning to the network monitoring manager;
making a determination that the probing packet meets a lifecycle-ending condition, wherein when the probing packet meets the lifecycle-ending condition the probing packet is not forwarded from the network device towards a network device associated with a destination internet protocol (IP) address in a header of the probing packet;
based on the determination, performing, by the network device, a packet analysis on the probing packet to determine an egress interface of the network device that would be used to forward the probing packet if the probing packet had not met the lifecycle ending condition, the packet analysis including analyzing the header of the probing packet to determine a destination address specified in the header, determining a destination network device corresponding to the specified destination address, and determining which egress interface is on a path to an ingress interface of the destination network device; and
based on the packet analysis, sending a notification to a network monitoring manager, wherein the notification specifies the egress interface.

2. The method of claim 1, wherein the lifecycle-ending condition comprises a time-to-live (TTL) value of the probing packet.

3. (canceled)

4. The method of claim 1, wherein the probing packet travels along a designated network path.

5. The method of claim 4, wherein the network monitoring manager updates the designated network path after obtaining the notification.

6. The method of claim 1, wherein the network monitoring manager stores an identifier of the egress interface in a database.

7. The method of claim 1, wherein the packet analysis is performed by a packet processor executing on a control plane of the network device.

8. A network device, comprising:
a hardware layer, wherein the hardware layer is programmed to:
receive a probing packet;
make a determination that the probing packet meets a lifecycle-ending condition; and
provide, in response to determination, the probing packet to a packet processor of the network device;
a packet processor, programmed to:
obtain the probing packet;
perform a packet analysis to obtain packet information, the packet analysis including analyzing the header of the probing packet to determine a destination address specified in the header, determining a destination network device corresponding to the specified destination address, and determining which egress interface is on a path to an ingress interface of the destination network device; and
based on the packet analysis, provide the packet information to a network monitoring manager.

9. The network device of claim 8, wherein the lifecycle-ending condition comprises a time-to-live (TTL) value.

10. (canceled)

11. The network device of claim 8, wherein the probing packet travels along a designated network path.

12. The network device of claim 8, wherein the packet analysis is performed by a packet processor of the network device.

13. The network device of claim 8, wherein the packet information comprises an egress interface of the network device from which the probing packet would have been transmitted.

14. A method for managing a network, the method comprising:
performing, by a network device, a packet analysis on a probing packet to determine an egress interface of the network device from which the probing packet would have been transmitted, the packet analysis including analyzing the header of the probing packet to determine a destination address specified in the header, determining a destination network device corresponding to the specified destination address, and determining which egress interface is on a path to an ingress interface of the destination network device,
wherein the probing packet is not transmitted out of the egress interface,
wherein the packet analysis is performed in a control plane of the network device when the probing packet meets a lifecycle-ending condition; and
based on the packet analysis, sending a notification to a network monitoring manager, wherein the notification specifies header information of the probing packet and the egress interface.

15. The method of claim 14, wherein the lifecycle-ending condition comprises a time-to-live (TTL) value of 0 or 1.

16. (canceled)

17. The method of claim 14, wherein the probing packet travels along a designated network path.

18. The method of claim 17, wherein the network monitoring manager updates the designated network path after obtaining the notification.

19. The method of claim 14, wherein the network monitoring manager stores an identifier of the egress interface in a database.

20. The method of claim 14, wherein the notification further comprises an ingress interface.
